(19) United States
(12) Patent Application Publication
(10) Pub. No.: US 2014/0040459 A1
(43) Pub. Date: Feb. 6, 2014

(54) SYSTEM AND METHOD FOR DATA COMMUNICATION USING A CLASSIFIED FLOW TABLE IN OPENFLOW NETWORKS

(71) Applicant: HEWLETT-PACKARD DEVELOPMENT COMPANY, L.P., Houston, TX (US)

(72) Inventors: Ankita Agrawal, Bangalore (IN); Rangaprasad Sampath, Bangalore (IN)

(73) Assignee: Hewlett-Packard Development Company, L.P., Houston, TX (US)

(21) Appl. No.: 13/887,620

(22) Filed: May 6, 2013

(30) Foreign Application Priority Data
Aug. 1, 2012 (IN) 3165/CHE/2012

(51) Int. Cl. H04L 12/721

(52) U.S. Cl. CPC H04L 45/14
USPC 709/224

(57) ABSTRACT

A system and method for data communication in OpenFlow networks are disclosed, In one example, each flow entry, in a flow table in an OpenFlow switch of a network device, is classified as an active flow entry or an inactive flow entry upon detecting a change in a system state event or when a new flow entry is programmed by an OpenFlow controller in the OpenFlow network. Further, each incoming packet is matched against each active flow entry in the flow table by the OpenFlow switch until a matching active flow entry is found. Furthermore, each incoming packet is forwarded from the OpenFlow switch based on the found matching active flow entry in the flow table.

### BACKGROUND

Typically, in an OpenFlow network, the control logic is not a part of a network device, rather the control logic resides in an external device, such as an OpenFlow controller. The OpenFlow controller communicates information related to forwarding rules, based on packet headers of packets, to the network device. The flow of packets through the network device, for further transferring, is controlled based on the forwarding rules. Generally, a single OpenFlow controller can operate to communicate the information related to forwarding rules to one or more network devices. Therefore, the functioning and configuration of the network devices become simpler, troubleshooting the network device becomes easier, and the cost of the network devices gets reduced, which results in a cost effective implementation of a computer network using the OpenFlow technology.

In the existing OpenFlow technology, the flows i.e., the information related to forwarding rules of the packets, pushed by the OpenFlow controller are housed in a flow table on the network device. It is possible that some of the flows in the flow table may never get matched because of an underlying system condition on the network device, such as a port that may be down. For example, consider a flow entry in the flow table that has a condition to match on a specific incoming port, say a port 10 and if the port 10 is down, for some reason, none of the packets can come into the network device via the port 10. Therefore, the flow entry associated with the port 10 may never get matched. Similarly, for many such reasons, there could be flow entries in the flow table whose actions may not be realized on the network device. For example, there could be a flow entry with an action to send packets out of the port 10, and as described above if for any reason the port 10 is down, the action of the flow entry may not be realized. It can be seen that such inactive flow entries can take up significant amount of space in the flow table having no utility. Keeping such inactive flow entries can lead to increased flow match time, i.e., the time taken to find a flow entry whose condition matches an incoming packet.

### BRIEF DESCRIPTION OF THE DRAWINGS

Examples of the invention will now be described in detail with reference to the accompanying drawings, in which:

FIG. 1 illustrates an example block diagram of a system including active and inactive flows that are housed in an OpenFlow switch software module for data communication in OpenFlow networks;

FIG. 2 illustrates an example block diagram of a system including the inactive flows housed in the OpenFlow switch software module and the active flows configured in an OpenFlow switch hardware module for the data communication in the OpenFlow networks;

FIG. 3 illustrates an exemplary flow entry;

FIGS. 4A-D illustrate example flow entries that could be declared as inactive flow entries on a OpenFlow switch in a network device;

FIG. 5 illustrates a flow diagram of an exemplary method for the data communication in OpenFlow networks using a system such as shown in FIGS. 1 and 2; and

FIG. 6 illustrates a flow diagram of an exemplary method for classification of flows based on changes in system state events.

The drawings described herein are for illustration purposes only and are not intended to limit the scope of the present disclosure in any way.

### DETAILED DESCRIPTION

A system and method for data communication using a classified flow table in OpenFlow networks are disclosed. In the following detailed description of the examples of the present subject matter, references are made to the accompanying drawings that form a part hereof, and in which are shown by way of illustration specific examples in which the present subject matter may be practiced. These examples are described in sufficient detail to enable those skilled in the art to practice the present subject matter, and it is to be understood that other examples may be utilized and that changes may be made without departing from the scope of the present subject matter. The following detailed description is, therefore, not to be taken in a limiting sense, and the scope of the present subject matter is defined by the appended claims.

The terms “flows” and “flow entries” are used interchangeably throughout the document.

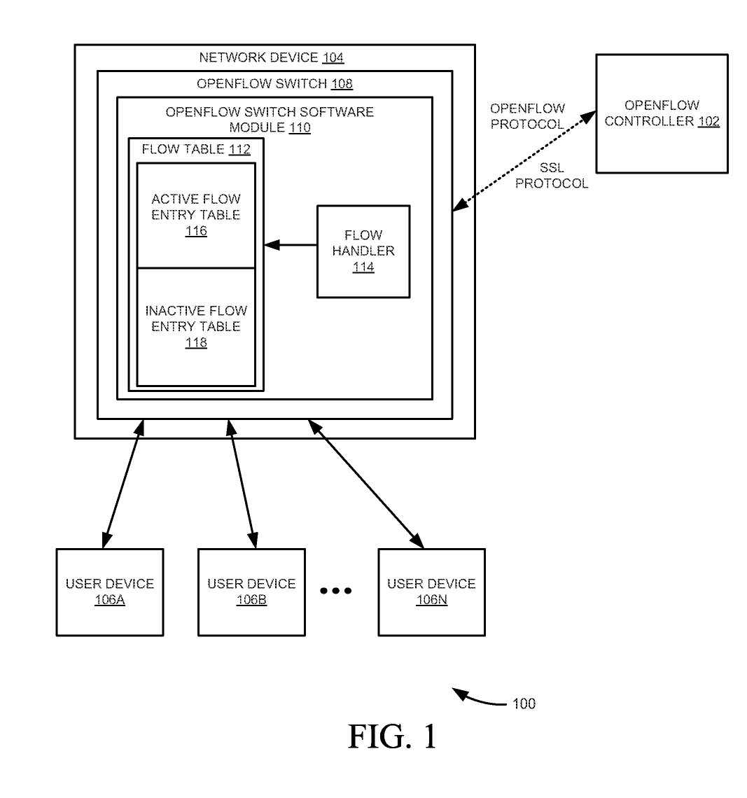

FIG. 1 illustrates an example block diagram 100 of a system including active and inactive flows that are housed in an OpenFlow switch software module 110 for data communication in OpenFlow networks. As shown in FIG. 1, the system includes an OpenFlow controller 102, a network device 104, and a plurality of user devices 106A-N. Further, the network device 104 includes an OpenFlow switch 108. Furthermore, the OpenFlow switch 108 includes the OpenFlow switch software module 110. In addition, the OpenFlow switch software module 110 includes a flow table 112 and a flow handler 114. Moreover, the user devices 106A-N are communicatively coupled to the OpenFlow switch 108. Also, the OpenFlow controller 102 is communicatively coupled to the OpenFlow switch 108. For example, the OpenFlow controller 102 and the OpenFlow switch 108 communicate with each other using an OpenFlow protocol. Further, the connection between the OpenFlow controller 102 and the OpenFlow switch 108 is secured using a secure socket layer (SSL) protocol. For example, the OpenFlow controller 102 is communicatively coupled to the OpenFlow switch 108 through a secure channel using the OpenFlow protocol. Further, the flow handler 114 is coupled to the flow table 112.

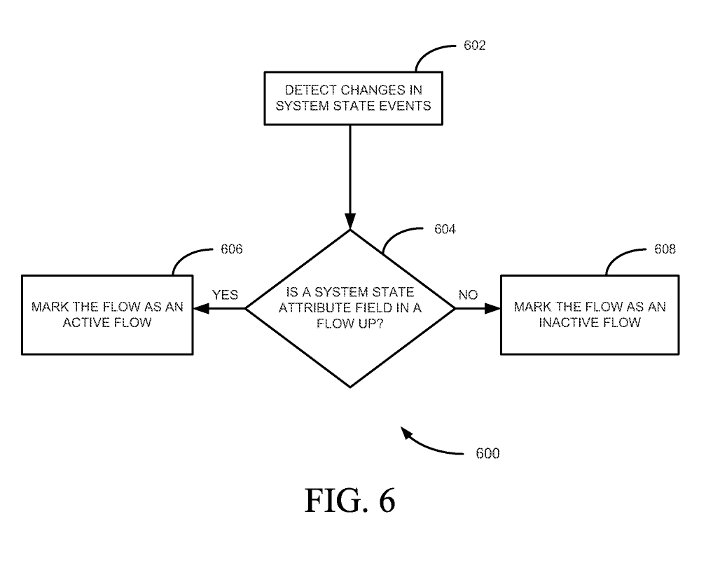

In operation, the flow handler 114 classifies each flow entry, in the flow table 112, as an active flow entry or an inactive flow entry upon detecting a change system state event on the OpenFlow switch 108 or on a flow addition by the OpenFlow controller 102. For example, the change in the system state event includes a port status change, a virtual local area network (VLAN) status change, port renumbering, a logical port status change, enable or disable of specific OpenFlow capabilities and the like. This is explained in more detail with reference to FIG. 6. In one exemplary implementation, the flow handler 114 forms the flow table 112 by partitioning the flow table 112 into an active flow entry table 116 and an inactive flow entry table 118 based on the classification. For example, data structures associated with the active flow entry table 116 and the inactive flow entry table 118 are included in the OpenFlow switch software module 110. In another exemplary implementation, the flow handler 114 forms the flow table including an additional attribute in each flow entry to indicate whether the flow entry is the active flow entry or the inactive flow entry.

Further, the flow handler 114 matches each incoming packet against each active flow entry in the flow table 112 until a matching active flow entry is found. In one example, the flow hander 114 matches each incoming packet against each active flow entry in the active flow entry table 116 until a matching active flow entry is found. In another example, the flow handler 114 matches each incoming packet against each flow entry including the attribute associated with the active flow entry. Furthermore, the flow handler 114 forwards each incoming packet from the OpenFlow switch 108 based on the found matching active flow entry.

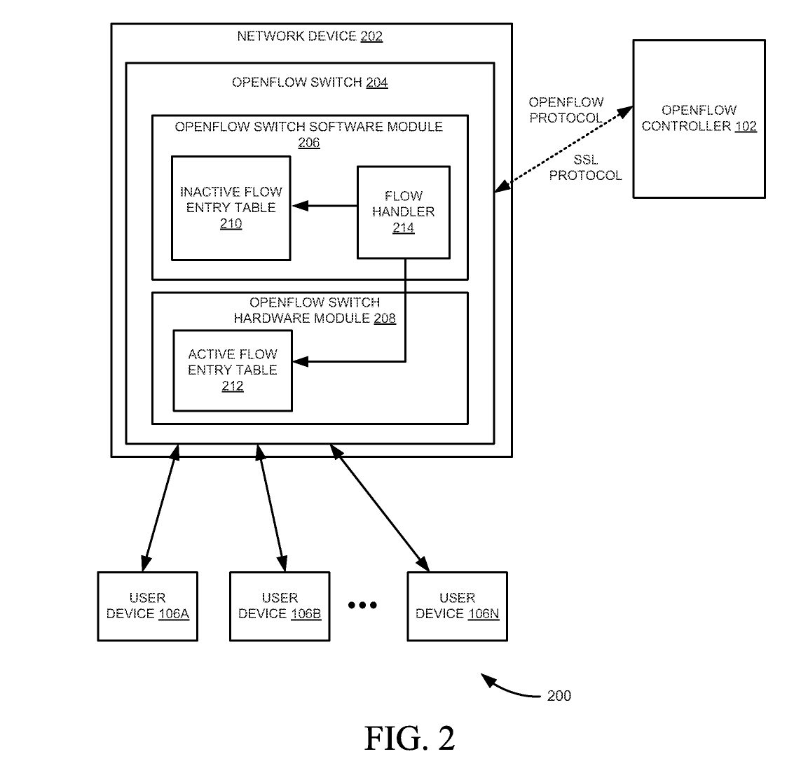

Referring now to FIG. 2, which is an example block diagram 200 that illustrates a system including inactive flows housed in an OpenFlow switch software module 206 and active flows configured in an OpenFlow switch hardware module 208 for the data communication in the OpenFlow networks. As shown in FIG. 2, the system includes the OpenFlow controller 102, a network device 202, and the user devices 106A-N. Further, the network device 202 includes an OpenFlow switch 204. Furthermore, the OpenFlow switch 204 includes the OpenFlow switch software module 206 and the OpenFlow switch hardware module 208. In addition, the OpenFlow switch software module 206 includes an inactive flow entry table 210 and a flow handler 214. For example, the OpenFlow switch software module 206 includes a data structure associated with the inactive flow entry table 210.

Further, the OpenFlow switch hardware module 208 includes an active flow entry table 212. For example, the OpenFlow switch hardware module 208 includes a data structure associated with the active flow entry table 212. Also, the user devices 106A-N are communicatively coupled to the OpenFlow switch 204. Furthermore, the OpenFlow controller 102 is communicatively coupled to the OpenFlow switch 204 through the secure channel using the OpenFlow protocol. In addition, the flow handler 214 is coupled to the inactive flow entry table 210 and active flow entry table 212.

In operation, the flow handler 214 classifies each flow entry as an active flow entry or an inactive flow entry upon detecting a change in a system state event or when a new flow is programmed by the OpenFlow controller 102. This is explained in more detail with reference to FIG. 6. Further, the flow handler 214 matches each incoming packet against each active flow entry in the active flow entry table 212 by the OpenFlow switch 204 until a matching active flow entry is found. Furthermore, the flow handler 214 forwards each incoming packet from the OpenFlow switch 204 based on the found matching active flow entry in the active flow entry table 212.

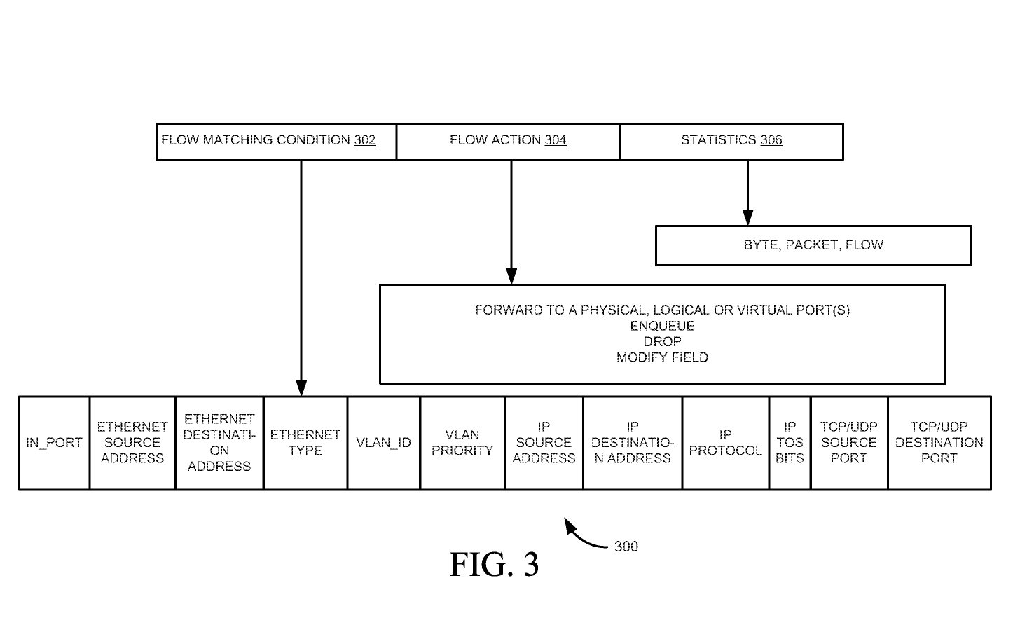

Referring now to FIG. 3, which illustrates an exemplary flow entry 300. As shown in the FIG. 3, the flow entry 300 includes a flow matching condition field 302, a flow action field 304, and a statistics field 306. Further, the flow matching condition field 302 includes sub-fields, such as an ingress port (in_port), Ethernet source and destination addresses, an Ethernet type, a VLAN identity (VLAN_ID), a VLAN priority, Internet protocol (IP) source and destination addresses, an IP protocol, IP type of service (ToS) bits, and transport control protocol (TCP)/user datagram protocol (UDP) source and destination ports. For example, the sub-fields in the flow matching condition field 302 take values based on an OpenFlow switch and packet headers of the packets received at the OpenFlow switch, such as shown in FIGS. 1 and 2. The values of the sub-fields can also include wild cards or don't cares. Furthermore, the flow action field 304 includes information that defines action rules and is indicative of forwarding the packets to a physical, logical or virtual port(s), enqueuing the packets, dropping of the packets, modify field actions and the like. In addition, the statistics field 306 includes information associated with a number of incoming packets or bytes matched with the flow entries, and the like. In one exemplary implementation, each flow entry in the flow table is classified as an active flow entry or inactive flow entry upon detecting a change in a system state event or when a new flow entry is programmed by an OpenFlow controller, such as the one shown in FIG. 1. This is explained in more detail with reference to FIG. 6. For example, the new flow entry is classified as an active flow entry when the condition of the flow is matched by packets corning into the network device and the action of the flow is realized by the network device.

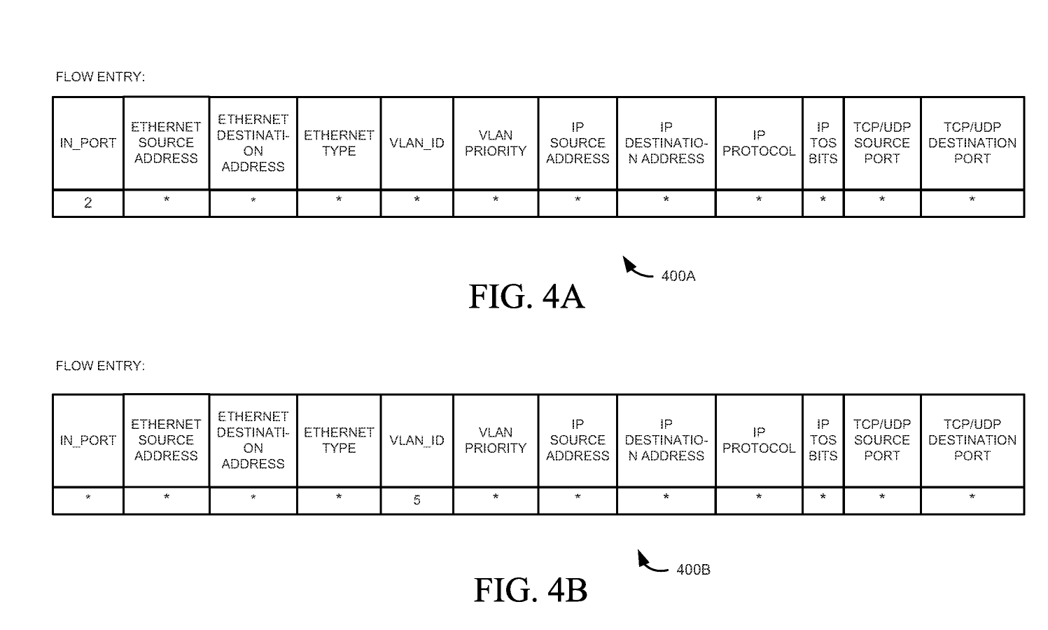

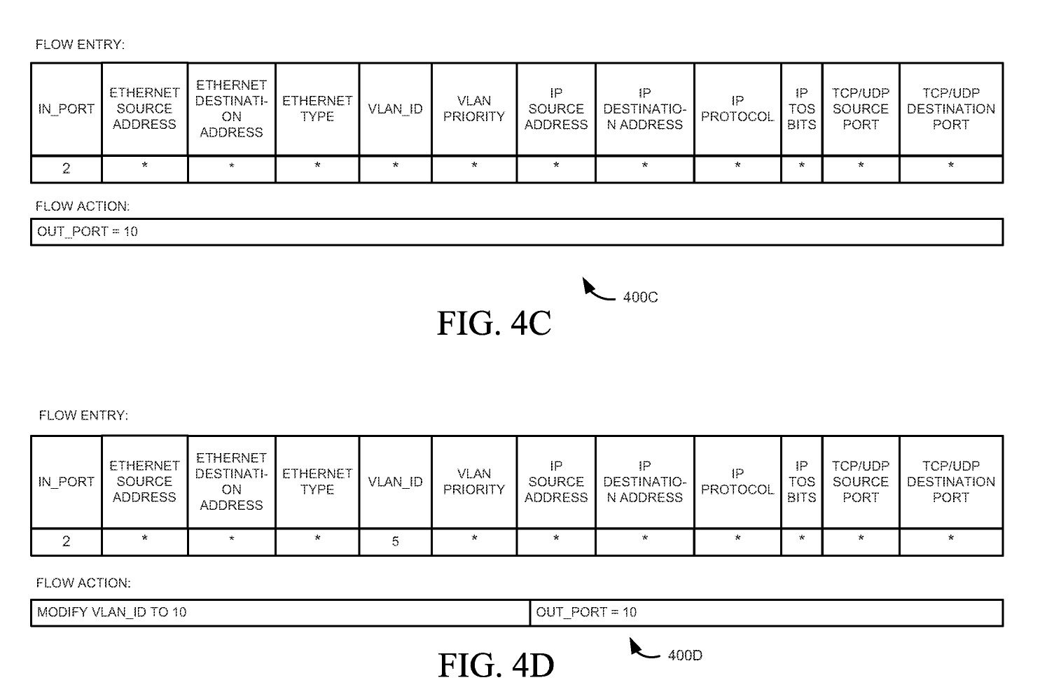

Referring now to FIGS. 4A-D, which illustrate example flow entries 400A-D that could be declared as inactive flow entries on an OpenFlow switch in a network device. As shown in FIG. 4A, the flow entry 400A includes a port 2 as an in_port in a flow matching condition. Further, when the port 2 goes down, this is detected as a change in the system state event occurred on the network device. As the port 2 is down, packets no longer come into the network device on this port and the flow entry 400A could be declared as the inactive flow entry. As shown in FIG. 4B, the flow entry 400B includes a VLAN 5 as a VLAN_ID in the flow matching condition. Further, when the VLAN 5 goes down, this is detected as a change in the system state event. As the VLAN 5 is down, packets no longer come into the network device on this VLAN and the flow entry 400B could be declared as the inactive flow entry.

As shown in FIG. 4C, the flow entry 400C includes the port 2 as the in_port and a port 10 as an out_port in a flow action. Further, when the port 10 goes down, this is detected as a change in the system state event. As the port 10 is down, the action associated the flow entry cannot be realized by the network device and the flow entry 400C could be declared as the inactive flow entry. As shown in FIG. 4D, the flow entry 400D includes the VLAN 5 as the VLAN_ID and the port 2 as the in_port, in the flow matching condition. Further, the flow action indicates modify VLAN_ID to VLAN 10 and the port 10 as the out_port. Furthermore, if modify VLAN 10 action is not supported on the network device, the action of the flow entry 400D cannot be realized on the network device. Though the ports 2 and 10 are up, the network device does not support the modify VLAN_ID action of the flow entry 400D and could be declared as the inactive flow entry.

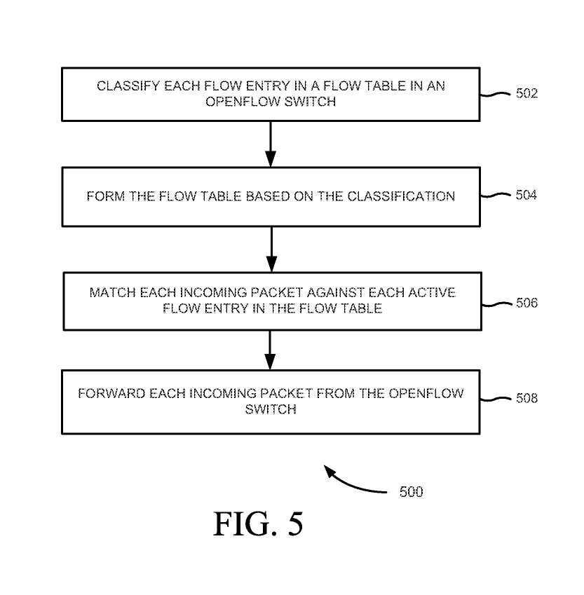

Referring now to FIG. 5, which is a flow diagram 500 that illustrates an exemplary method for data communication in OpenFlow networks using a system, such as shown in FIGS. 1 and 2. At block 502, each flow entry, in a flow table in an OpenFlow switch of a network device, is classified as an active flow entry or an inactive flow entry upon detecting a change in a system state event or when a new flow entry is programmed by an OpenFlow controller in the OpenFlow network. This is explained in more detail with reference to FIG. 6. For example, the change in the system state event includes a port status change, a virtual local area network (VLAN) status change, a port renumbering change, a logical port status change, enable or disable of specific OpenFlow capabilities and the like. In one exemplary implementation, classification of each flow entry in the flow table as the active flow entry or the inactive flow entry is not required upon detecting a frequent change in the system state event. For example, classification of each flow entry in the flow table is not required when a specific change in the system state event occurs within the last 30 seconds.

At block 504, the flow table is formed based on the classification. In one exemplary implementation, the flow table is formed by partitioning the flow table into an active flow entry table and an inactive flow entry table based on the classification. In one example, data structures associated with the active flow entry table and the inactive flow entry table are included in an OpenFlow switch software module residing in the OpenFlow switch. This is explained in more detail with reference to FIG. 1. In another example, the data structure associated with the active flow entry table is included in an OpenFlow switch hardware module associated with the OpenFlow switch and the data structure associated with the inactive flow entry table is included in the OpenFlow switch software module. This is explained in more detailed with reference to FIG. 2. For example, the OpenFlow switch hardware module includes an application specific integrated circuit (ASIC) that houses the data structure associated with the active flow entry table. In another exemplary implementation, the flow table including an additional attribute in each flow entry to indicate whether the flow entry is the active flow entry or the inactive flow entry is formed.

At block 506, each incoming packet is matched against each active flow entry in the flow table by the OpenFlow switch until a matching active flow entry is found. In one exemplary implementation, each incoming packet is matched against each active flow entry in the active flow entry table. In another exemplary implementation, each incoming packet is matched against each flow entry including the attribute associated with the active flow entry. At block 508, each incoming packet is forwarded from the OpenFlow switch based on the matching active flow entry found in the flow table.

Referring now to FIG. 6, which is a flow diagram 600 that illustrates an exemplary method for classification of flows based on changes in system state events. At block 602, the changes in the system state events occurred on a network device are detected. For example, the change in the system state event includes a port status change, a virtual local area network (VLAN) status change, port renumbering, a logical port status change, enable or disable of specific OpenFlow capabilities and the like. In one example, arrival of a new flow entry from an OpenFlow controller is also considered as a change in the system state event. At block 604, it is determined whether a system state attribute field in a flow is up. The flow includes an existing flow entry or the new flow entry. For example, the system state attribute field includes port status, port bandwidth status, VLAN status, process utilization status, memory utilization status, power consumed status, flow table size supported status, flow table size available status, and the like.

At block 606, the flow is marked as an active flow if the system state attribute field in the flow is up. For example, if status of a port is changed from down to up then all inactive flows that have considered the port as the in_port in the flow match condition or the out_port in the flow action would now get marked as active flows. Further, if status of a VLAN is changed from down to up then all inactive flows that that have the considered the VLAN as VLAN_ID in the flow match condition would now get marked as active flows. Furthermore, if a modify VLAN_ID action has changed from disable to enable then all inactive flows that have the enabled action as the flow action would get marked as active flows.

At block 608, the flow is marked as an inactive flow if the system state attribute field in the flow is down. For example, if status of a port is changed from up to down then all active flows that have considered the port as an in port in the flow match condition or an out port in the flow action would now get marked as inactive flows. Further, if status of a VLAN is changed from up to down then all active flows that have the considered the VLAN as a VLAN_ID in the flow match condition would now get marked as inactive flows. Furthermore, if a modify VLAN_ID action has changed from enable to disable then all active flows that have the disabled action as the flow action would get marked as inactive flows.

In one example, a flow handler, such as shown in FIGS. 1 and 2 described above may be in the form of instructions stored on a non transitory computer readable storage medium. An article includes the non transitory computer readable storage medium having the instructions that, when executed by a physical computing device, causes the computing device to perform the one or more methods described in FIGS. 1-6.

In various examples, the systems and methods described in FIGS. 1 through 6 propose a mechanism to classify flows as active or inactive flows based on an underlying system state and the consequent partitioning of the flow table into active and inactive flow tables. Further, the incoming packets are matched only against the active flow table resulting in a reduction of the flow lookup time because of the lesser number of flow entries to match. Furthermore, the mechanism also provides an opportunity to implement the entire active flow table in the OpenFlow switch hardware module which improves system performance.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method for data communication in an OpenFlow network, comprising:
classifying each flow entry, in a flow table in an OpenFlow switch of a network device, as an active flow entry or an inactive flow entry upon detecting a change in a system state event or when a new flow entry is programmed by an OpenFlow controller in the OpenFlow network;
matching each incoming packet against each active flow entry in the flow table by the OpenFlow switch until a matching active flow entry is found; and
forwarding each incoming packet from the OpenFlow switch based on the found matching active flow entry in the flow table.

2. The method of claim 1, wherein the change in the system state event is selected from the group consisting of a port status change, a virtual local area network (VLAN) status change, port renumbering, a logical port status change, and enable or disable of specific OpenFlow capabilities.

3. The method of claim 1, further comprising:
forming the flow table by partitioning the flow table into an active flow entry table and an inactive flow entry table based on the classification.

4. The method of claim 3, wherein matching each incoming packet against each active flow entry in the flow table comprises:
matching each incoming packet against each active flow entry in the active flow entry table.

5. The method of claim 3, further comprising:
including data structures associated with the active flow entry table and the inactive flow entry table in an OpenFlow switch software module residing in the OpenFlow switch.

6. The method of claim 3, further comprising:
including a data structure associated with the active flow entry table in an OpenFlow switch hardware module associated with the OpenFlow switch and a data structure associated with the inactive flow entry table in an OpenFlow switch software module residing in the OpenFlow switch.

7. The method of claim 6, wherein the OpenFlow switch hardware module comprises an application specific integrated circuit (ASIC) that houses the data structure associated with the active flow entry table.

8. The method of claim 1, further comprising:
forming the flow table including an additional attribute in each flow entry to indicate whether the flow entry is the active flow entry or the inactive flow entry.

9. The method of claim 8, wherein matching each incoming packet against each active flow entry in the flow table comprises:
matching each incoming packet against each flow entry including the attribute associated with the active flow entry.

10. An OpenFlow network, comprising:
an OpenFlow controller;
an OpenFlow switch of a network device communicatively coupled to the OpenFlow controller; and
one or more user devices communicatively coupled to the OpenFlow switch of the network device, wherein the OpenFlow switch comprises a flow handler configured to provide to:
classify each flow entry, in a flow table in the OpenFlow switch of the network device, as an active flow entry or an inactive flow entry upon detecting a change in a system state event on the OpenFlow switch or on a flow addition by the OpenFlow controller;
match each incoming packet against each active flow entry in the flow table until a matching active flow entry is found; and
forward each incoming packet from the OpenFlow switch based on the found matching active flow entry in the flow table.

11. The OpenFlow network of claim 10, wherein the flow handler is further configured to:
form the flow table by partitioning the flow table into an active flow entry table and an inactive flow entry table based on the classification.

12. The OpenFlow network of claim 10, wherein the flow handler is further configured to:
form the flow table including an additional attribute in each flow entry to indicate whether the flow entry is the active flow entry or the inactive flow entry.

13. A non-transitory computer-readable storage medium for data communication in OpenFlow networks having instructions that when executed by a computing device, cause the computing device to:
classify each flow entry, in a flow table in an OpenFlow switch of a network device, as an active flow entry or an inactive flow entry upon detecting a change in a system state event or when a new flow entry is programmed by an OpenFlow controller in the OpenFlow network;
match each incoming packet against each active flow entry in the flow table by the OpenFlow switch until a matching active flow entry is found; and
forward each incoming packet from the OpenFlow switch based on the found matching active flow entry in the flow table.

14. The non transitory computer-readable storage medium of claim 13, further comprising:
forming the flow table by partitioning the flow table into an active flow entry table and an inactive flow entry table based on the classification.

15. The non-transitory computer-readable storage medium of claim 13, further comprising:
forming the flow table including an additional attribute in each flow entry to indicate whether the flow entry is the active flow entry or the inactive flow entry.
